(19) United States
(12) Patent Application Publication
(10) Pub. No.: US 2025/0313467 A1
(43) Pub. Date: Oct. 9, 2025

(54) URANIUM PRECIPITATION VIA OZONE BUBBLING

(71) Applicant: UNIVERSITY OF NOTRE DAME DU LAC, South Bend, IN (US)

(72) Inventors: Savannah BENJAMIN, South Bend, IN (US); Peter BURNS, South Bend, IN (US)

(21) Appl. No.: 18/865,490

(22) PCT Filed: Jun. 1, 2023
(86) PCT No.: PCT/US2023/024160

§ 371 Date: Nov. 13, 2024

Related U.S. Application Data
(60) Provisional application No. 63/365,709, filed on Jun. 2, 2022.

(51) Int. Cl. C01B 15/047; B01J 4/00; B01J 10/00; B01J 19/06

(52) U.S. Cl. CPC C01B 15/0475; B01J 4/001; B01J 10/002; B01J 19/06; B01J 2204/002

(57) ABSTRACT

Methods of producing peroxides of uranium may include preparing an aqueous solution comprising uranyl ions (UO₂⁺²) in a vessel, bubbling ozone (O₃) through the aqueous solution comprising the uranyl ions, and recovering the peroxide of uranium. The peroxide of uranium may comprise at least one of studtite (UO₄·4(H₂O) or metastudtite (UO₄·2(H₂O).

### CROSS-REFERENCE TO RELATED APPLICATION(S)

This application claims priority to U.S. Provisional Patent Application No. 63/365,709, filed on Jun. 2, 2022, the entire contents of which are incorporated herein by reference.

### TECHNICAL FIELD

The present disclosure relates to materials, methods, and techniques for generating peroxides of uranium. Exemplary methods for generating peroxide compounds of uranium may comprise bubbling ozone (O₃) through aqueous solutions comprising uranyl ions (UO₂⁺²).

### INTRODUCTION

Industrial aqueous processes for uranium mining, such as in situ leaching (ISL), typically involve adding large quantities of hydrogen peroxide (H₂O₂) to uranium rich aqueous solutions to precipitate studtite (UO₄·4(H₂O)) and its lower hydrate, metastudtite (UO₄·2(H₂O)). However, transporting large quantities of hydrogen peroxide (H₂O₂) to remote locations is not feasible. Therefore, to mine uranium in remote locations, alternative studtite (UO₄·4(H₂O)) and metastudtite (UO₄·2(H₂O)) recover, methods are needed.

### SUMMARY

The present disclosure relates to methods of producing peroxides of uranium. The methods may comprise preparing an aqueous solution comprising uranyl ions (UO₂⁺²) in a vessel, bubbling ozone (O₃) through the aqueous solution comprising the uranyl ions, and recovering the peroxide of uranium. The peroxide of uranium may comprise at least one of studtite (UO₄·4(H₂O)) or metastudtite (UO₄·2(H₂O)). The uranyl ion source may comprise a uranyl salt. The uranyl salt may comprise UO₂(NO₃)₂, UO₂SO₄, UO₂CO₃, or UO₂(CH₃CO₂)₂. The aqueous solution comprising uranyl ions may have a pH of less than 9. The aqueous solution comprising uranyl ions may have a pH of 3-6. Bubbling ozone (O₃) through the aqueous solution comprising uranyl ions may occur for a time period of 1 minute to 72 hours. Bubbling ozone (O₃) through the aqueous solution comprising uranyl ions may occur for a time period of 12 hours to 58 hours. While bubbling ozone (O₃) through the aqueous solution comprising the uranyl ions, the aqueous solution may be maintained at a temperature of 0.1° C. to 99.9° C. While bubbling ozone (O₃) through the aqueous solution comprising the uranyl ions, the aqueous solution may be maintained at a temperature of 30° C. to 60° C. While bubbling ozone (O₃) through the aqueous solution comprising the uranyl ions, the aqueous solution may be maintained at a pressure of 0.0001 MPa to 1.0 MPa. An ozone diffuser may bubble the ozone (O₃) through the aqueous solution comprising the uranyl ions. Bubbling ozone (O₃) may comprise contacting the aqueous solution comprising the uranyl ions with a bubbling tube, diffusing stone, or needle. The ozone bubbles may have an average diameter of 1 μm to 10,000 μm. Ozone may be provided into the aqueous solution at a flow rate of 0.01 standard cubic centimeters per minute (MPa·cm³/min) to 100 MPa·cm³/min. While bubbling ozone (O₃) through the aqueous solution comprising the uranyl ions, the aqueous solution may have an ozone content of greater than about 10 parts per billion (ppb).

In another aspect, a system for generating a peroxide of uranium is disclosed. The system for generating a peroxide of uranium may comprise a vessel containing an aqueous solution comprising uranyl ions (UO₂⁺²), wherein the vessel is in fluid communication with an ozone (O₃) source and a filter unit. The uranyl ion source may comprise a uranyl salt. The ozone (O₃) source may comprise a bubbling tube in fluid communication with an ozone diffuser. The filter unit may be configured to generate a solids portion comprising the peroxide of uranium and a liquid portion comprising filtrate. The peroxide of uranium may comprise at least one of studtite (UO₄·4(H₂O)) or metastudtite (UO₄·2(H₂O)).

In another aspect, a peroxide of uranium is disclosed. The peroxide of uranium may be formed by a process comprising preparing an aqueous solution comprising uranyl (UO₂⁺²) ions in a vessel, bubbling ozone (O₃) through the aqueous solution comprising the uranyl ions, and recovering the peroxide of uranium. The peroxide of uranium may comprise at least one of studtite (UO₄·4(H₂O)) or metastudtite (UO₄·2(H₂O)).

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### BRIEF DESCRIPTION OF THE DRAWINGS

FIG. 1 is a flowchart of an exemplary method for preparing exemplary peroxides of uranium.

FIG. 2 is a schematic depiction of an exemplary system for preparing exemplary peroxides of uranium.

FIG. 3 shows Raman spectra of experimentally formed studtite precipitate (bottom) and studtite reference (top).

FIG. 4 shows powder diffractograms of the recovered precipitate (black trace) with studtite (blue trace) and uranyl nitrate (red trace) patterns for reference.

### DETAILED DESCRIPTION

Exemplary materials, methods and techniques disclosed and contemplated herein generally relate to peroxides of uranium and methods for preparing the same. The methods described herein comprise bubbling ozone (O₃) through aqueous solutions comprising uranyl ions (UO₂) to produce peroxides of uranium (UO₄·n(H₂O)).

As shown in equation (1), ozone (O₃) may react with the aqueous solution's water molecules to generate hydrogen peroxide (H₂O₂) in situ. The in situ-formed hydrogen peroxide (H₂O₂) may subsequently react with the aqueous solution's uranyl ions (UO₂⁺²) to produce a peroxide of uranium (UO₄·n(H₂O)).

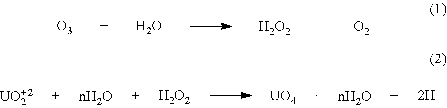

### I. Definitions

Unless otherwise defined, all technical and scientific terms used herein have the same meaning as commonly understood by one of ordinary skill in the art. In case of conflict, the present document, including definitions, will control. Methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, the term “about” is used to indicate that exact values are not necessarily attainable. Therefore, the term “about” is used to indicate this uncertainty limit. The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5-1.4. The modifier “about” should also be considered as disclosing the range defined by the absolute values of the two endpoints. For example, the expression “from about 2 to about 4” also discloses the range “from 2 to 4.”

For the recitation of numeric ranges herein, each intervening number there between with the same degree of precision is contemplated. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are contemplated. For another example, when a pressure range is described as being between ambient pressure and another pressure, a pressure that is ambient pressure is expressly contemplated.

### II. Exemplary Materials

Exemplary methods and techniques use and recover various materials. Exemplary materials include aqueous solutions comprising uranyl ions (UO₂⁺²), ozone (O₃) sources, and peroxides of uranium. Various aspects of exemplary aqueous solutions comprising uranyl ions (UO₂⁺²), ozone (O₃) sources, and peroxides of uranium are discussed below.

A. Exemplary Aqueous Solutions Comprising Uranyl Ions (UO₂⁺²)

Various aspects of exemplary aqueous solutions comprising uranyl ions (UO₂⁺²) are discussed below. As used herein “an aqueous solution” is any solution comprising water as the solvent.

1. Uranyl Ion (UO₂⁺²) Source

Exemplary aqueous solutions comprising uranyl ions (UO₂⁺²) may be prepared by dissolving a uranyl ion source in water. As used herein, “a uranyl ion source” is any substance that contains uranyl ions (UO₂⁺²) or that may be transformed into uranyl ions (UO₂⁺²) in an aqueous solution. Exemplary uranyl ion sources include uranyl salts (UO₂(X)₁₋₂), such as UO₂(NO₃)₂, UO₂SO₄, UO₂CO₃, and UO₂(CH₃CO₂)₂. In some instances, exemplary uranyl salts may be present as a hydrate. For example, in some instances, the uranyl salt may be a dihydrate salt (UO₂(X)₁₋₂·2(H₂O)) or a hexahydrate salt (UO₂(X)₁₋₂·6(H₂O)).

2. Uranyl Ion (UO₂⁺²) Concentration

Exemplary aqueous solutions may have a uranyl ion (UO₂⁺²) concentration of 0.0001 M to 1 M. In various instances, exemplary aqueous solutions may have a uranyl ion (UO₂⁺²) concentration of 0.00025 M to 0.75 M; 0.0005 M to 0.5 M; 0.00075 M to 0.25 M; 0.001 M to 0.1 M; 0.0025 M to 0.075 M; 0.005 M to 0.05 M; or 0.0075 to 0.025 M. In various instances, exemplary aqueous solutions may have a uranyl ion (UO₂⁺²) concentration of no greater than 1 M; no greater than 0.75 M; no greater than 0.5 M; no greater than 0.25 M; no greater than 0.1 M; no greater than 0.075; no greater than 0.05 M; no greater than 0.025; no greater than 0.01 M; no greater than 0.0075 M; no greater than 0.005 M; no greater than 0.0025; no greater than 0.001 M; no greater than 0.00075 M; or no greater than 0.0005 M. In various instances, exemplary aqueous solutions may have a uranyl ion (UO₂⁺²) concentration of no less than 0.0001 M; no less than 0.00025 M; no less than 0.0005 M; no less than 0.00075 M; no less than 0.001 M; no less than 0.0025 M; no less than 0.005 M; no less than 0.0075 M; no less than 0.01 M; no less than 0.025 M; no less than 0.05 M; no less than no less than 0.1 M; no less than 0.25 M; no less than 0.5 M; or no less than 0.75 M.

3. pH

Exemplary aqueous solutions comprising uranyl ions may have a pH of less than 9. In some instances, exemplary aqueous solutions comprising uranyl ions may have a pH of less than 8.5; less than 8; less than 7.5; less than 7; less than 6.5; less than 6; less than 5.5; or less than 5. In some instances, exemplary aqueous solutions comprising uranyl ions may have a pH of 2 to 8; 2.5 to 7.5; 2.5 to 7; 2.5 to 6.5; 3 to 6; 3.5 to 5.5; or 4 to 5. In various instances, exemplary aqueous solutions comprising uranyl ions may have a pH of no less than 3; no less than 3.5; no less than 4; no less than 5; no less than 5.5; no less than 6; no less than 6.5; or no less than 7.

In various instances, a suitable pH adjusting agent may be added to the aqueous solution to achieve a specific pH value or range. As used herein “a pH adjusting agent” is an acidifying agent or alkalizing agent. An “acidifying agent” is an agent added to the solution to lower the pH, e.g., hydrochloric acid. An “alkalizing agent” is an agent added to the solution to increase the pH, e.g., sodium hydroxide. The particular pH adjusting agent may depend on the specific aqueous solution being treated. Exemplary pH adjusting agents include, without limitation, sodium hydroxide, potassium hydroxide, calcium hydroxide, hydrochloric acid, sulfuric acid, sodium sulfate, sodium nitrate, sodium chloride, sodium carbonate, potassium hydrogen carbonate, sodium hydrogen carbonate, magnesium sulfate, magnesium nitrate, magnesium chloride, magnesium carbonate, sodium triphosphate, potassium triphosphate, disodium hydrogenphosphate, dipotassium hydrogenphosphate, sodium dihydrogenphosphate, potassium dihydrogenphosphate, and sodium polyphosphate.

### B. Exemplary Ozone (O₃) Sources

As used herein, an “ozone (O₃) source” provides ozone (O₃) to an aqueous solution comprising uranyl ions. The particular ozone (O₃) source may depend on the specific aqueous solution.

In various instances, exemplary ozone (O₃) sources include any vessel containing ozone (O₃) (“ozone (O₃)-containing vessel”). Exemplary ozone (O₃)-containing vessels may comprise an attachment, such as a bubbling tube, diffusing stone, or needle, where the attachment comprises a fluid pathway for providing ozone (O₃) into exemplary aqueous solutions. In various instances, while providing ozone (O₃), exemplary attachments may contact the aqueous solutions, thus generating ozone (O₃) bubbles in the aqueous solutions.

In some instances, the ozone (O₃) source may be an ozone (O₃) diffuser. In various instances, exemplary ozone (O₃) diffusers may generate ozone (O₃) bubbles having an average diameter of 1 μm to 10,000 μm. In some instances, exemplary ozone (O₃) bubbles may have an average diameter of 5 μm to 5,000 μm; 10 μm to 1,000 μm; 25 μm to 750 μm; 50 μm to 500 μm; 75 μm to 250 μm; 100 μm to 200 μm; or 125 μm to 175 μm. In various instances, exemplary ozone (O₃) bubbles may have an average diameter of no greater than 10,000 μm; no greater than 5,000 μm; no greater than 1,000 μm; no greater than 750 μm; no greater than 500 μm; no greater than 250 m; no greater than 200 μm; no greater than 175 μm; no greater than 150 μm; no greater than 125 μm; no greater than 100 μm; no greater than 75 μm; no greater than 50 μm; no greater than 25 μm; no greater than 10 μm; or no greater than 1 μm. In various instances, exemplary ozone (O₃) bubbles may have an average diameter of no less than 1 μm; no less than 5 μm; no less than 10 μm; no less than 25 μm; no less than 50 m; no less than 75 μm; no less than 100 m; no less than 125 μm; no less than 150 m; no less than 175 μm; no less than 200 μm; no less than 250 μm; no less than 500 μm; no less than 750 μm; or no less than 1,000 μm.

### C. Exemplary Peroxides of Uranium

As used herein, “a peroxide of uranium” is a compound of formula UO₄·n(H₂O), where n is 0-4. Exemplary peroxides of uranium may be minerals. Two known peroxide of uranium minerals are studtite (UO₄·4(H₂O)) and metastudtite (UO₄·2(H₂O)).

Exemplary peroxides of uranium may have various exemplary physical properties. For example, in various instances, exemplary peroxides of uranium may be light yellow in color. In various instances, exemplary peroxides of uranium may be present in various solid forms, including, without limitation, crystals, and powders.

### III. Exemplary Methods

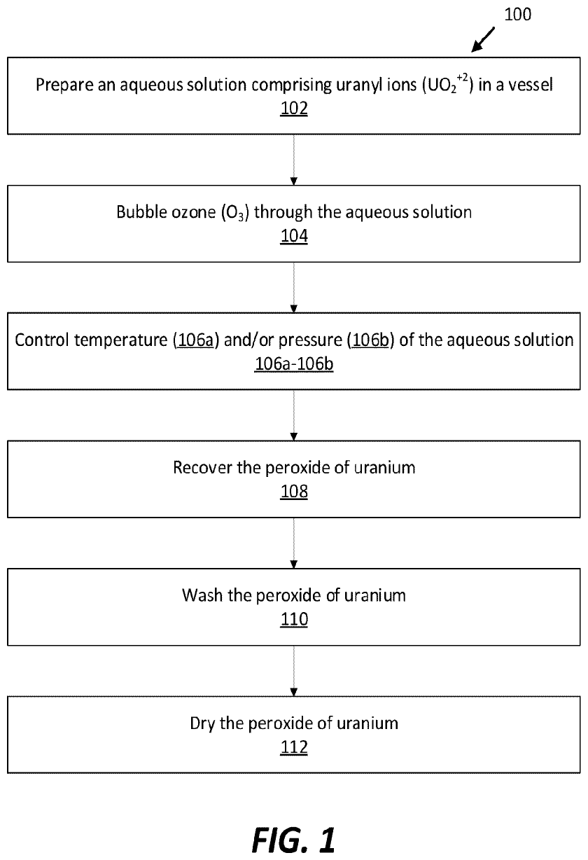

Exemplary methods for preparing peroxides of uranium disclosed and contemplated herein may include one or more exemplary operations. FIG. 1 shows an exemplary method 100 for preparing exemplary peroxides of uranium. Broadly, method 100 includes pre-bubbling operations, bubbling operations, and post-bubbling operations. As shown, method 100 includes preparing an aqueous solution comprising uranyl ions (UO₂⁺²) (operation 102), bubbling ozone (O₃) through the aqueous solution comprising the uranyl ions (operation 104), controlling temperature of the aqueous solution (operation 106a), controlling pressure of the aqueous solution environment (operation 106b), recovering the peroxide of uranium (operation 108), washing the peroxide of uranium (operation 110), and drying the peroxide of uranium (operation 112). Other embodiments may include more or fewer operations.

### A. Exemplary Pre-Ozone (O₃) Bubbling Operations

As shown in FIG. 1, exemplary method 100 may begin by preparing, in a vessel, an aqueous solution comprising uranyl ions (UO₂⁺²) (operation 102). In various instances, preparing exemplary aqueous solutions may involve, in a vessel, combining water and a uranyl ion source to form the aqueous solution comprising uranyl ions. Combining water and a uranyl source may involve adding a uranyl ion source to water, or, conversely, adding water to a uranyl ion source. In some instances, after combining the water and the uranyl ion source, the aqueous solution may be agitated or stirred.

In various instances, preparing exemplary aqueous solutions may involve adjusting the uranyl ion (UO₂⁺²) concentration of exemplary aqueous solutions. Adjusting the uranyl ion (UO₂⁺²) concentration of exemplary aqueous solutions may comprise adding water to the aqueous solution to decrease the UO₂⁺² concentration, or, conversely, adding uranyl ion source to the aqueous solution. In some instances, preparing exemplary aqueous solutions may comprise adjusting the pH by adding a suitable amount of a pH adjusting agent. Adjusting the pH of exemplary aqueous solutions may comprise adding a suitable acidifying agent to lower the pH, or, conversely, adding a suitable alkalizing agent to increase the pH.

Exemplary aqueous solutions and uranyl ion sources are described in greater detail above. For example, as previously described exemplary aqueous solutions comprising uranyl ions (UO₂⁺²) may have a uranyl ion (UO₂⁺²) concentration of 0.0001 M to 1 M, and a pH of less than 9.

### B. Exemplary Ozone (O₃) Bubbling Operations

After preparing the aqueous solution in a vessel (operation 102), exemplary method 100 may further comprise bubbling ozone (O₃) through the aqueous solution comprising the uranyl ions (operation 104). In various instances, bubbling ozone (O₃) comprises contacting the aqueous solution comprising the uranyl ions with a bubbling tube, diffusing stone, or needle.

In various instances, ozone (O₃) may be provided into the aqueous solution at a flow rate of 0.01 standard cubic centimeters per minute (MPa·cm³/min) to 100 MPa·cm³/min. In various instances, ozone (O₃) may be provided into the aqueous solution at a flow rate of 0.1 MPa·cm³/min to 100 MPa·cm³/min; 0.25 MPa·cm³/min to 75 MPa·cm³/min; 0.5 MPa·cm³/min to 50 MPa·cm³/min; 0.75 MPa·cm³/min to 25 MPa·cm³/min; 1.0 MPa·cm³/min to 20 MPa·cm³/min; 1.5 MPa·cm³/min to 15 MPa·cm³/min; 2.0 MPa·cm³/min to 12 MPa·cm³/min; or 2.5 MPa·cm³/min to 10 MPa·cm³/min. In various instances, ozone (O₃) may be provided into the aqueous solution at a flow rate of no greater than 100 MPa·cm³/min; no greater than 75 MPa·cm³/min; no greater than 50 MPa·cm³/min; no greater than 25 MPa·cm³/min; no greater than 20 MPa·cm³/min; no greater than 15 MPa·cm³/min; no greater than 10 MPa·cm³/min; no greater than 5 MPa·cm³/min; no greater than 2.5 MPa·cm³/min; no greater than 1 MPa·cm³/min; or no greater than 0.5 MPa·cm³/min. In various instances, ozone (O₃) may be provided into the aqueous solution at a flow rate of no less than 0.1 MPa·cm³/min; no less than 0.25 MPa·cm³/min; no less than 0.5 MPa·cm³/min; no less than 0.75 MPa·cm³/min; no less than 1.0 MPa·cm³/min; no less than 1.5 MPa·cm³/min, no less than 2.5 MPa·cm³/min; no less than 5 MPa·cm³/min; no less than 10 MPa·cm³/min; no less than 15 MPa·cm³/min; no less than 20 MPa·cm³/min; no less than 25 MPa·cm³/min; no less than 50 MPa·cm³/min; or no less than 75 MPa·cm³/min.

In various instances, while bubbling ozone (O₃) through the aqueous solution comprising the uranyl ions, the aqueous solution may have an ozone content of greater than about 10 parts per billion (ppb). In some instances, the aqueous solution may have an ozone content of greater than about 15 ppb; greater than about 20 ppb; greater than about 25 ppb; greater than about 30 ppb; greater than about 35 ppb; greater than about 40 ppb; greater than about 45 ppb; or greater than about 50 ppb.

In various instances, bubbling ozone (O₃) through the aqueous solution comprising uranyl ions may occur for a time period of 1 minute to 72 hours. In some instances, bubbling ozone (O₃) through the aqueous solution comprising uranyl ions may occur for a time period of 0.1 hours to 72 hours; 0.25 hours to 71 hours; 0.5 hours to 70 hours; 1 hour to 69 hours; 2 hours to 68 hours; 3 hours to 67 hours; 4 hours to 66 hours; 5 hours to 65 hours; 6 hours to 64 hours; 7 hours to 63 hours; 8 hours to 62 hours; 9 hours to 61 hours; 10 hours to 60 hours; 12 hours to 58 hours; 15 hours to 55 hours; 18 hours to 52 hours; 20 hours to 50 hours; 24 hours to 48 hours; 25 hours to 45 hours; 28 hours to 42 hours; or 30 to 40 hours. In various instances, bubbling ozone (O₃) through the aqueous solution comprising uranyl ions may occur for a time period of no greater than 72 hours; no greater than 70 hours; no greater than 65 hours; no greater than 60 hours; no greater than 55 hours; no greater than 50 hours; no greater than 48 hours; no greater than 45 hours; no greater than 42 hours; no greater than 40 hour; no greater than 35 hours; no greater than 30 hours; no greater than 24 hours; no greater than 20 hours; no greater than 15 hours; no greater than 10 hours; no greater than 5 hours; no greater than 2 hours; no greater than 1 hour; no greater than 0.5 hours; or no greater than or no greater than 0.25 hours. In various instances, bubbling ozone (O₃) through the aqueous solution comprising uranyl ions may occur for a time period of no less than 1 minute; no less than 0.1 hours; no less than 0.25 hours; no less than 0.5 hours; no less than 1 hour; no less than 2 hours; no less than 5 hours; no less than 8 hours; no less than 10 hours; no less than 12 hours; no less than 15 hours; no less than 18 hours; no less than 20 hours; no less than 24 hours; no less than 30 hours; no less than 35 hours; no less than 40 hours; no less than 45 hours; no less than 48 hours; no less than 50 hours; no less than 55 hours; no less than 60 hours; no less than 65 hours; or no less than 70 hours.

In some implementations, while bubbling ozone (O₃) through the aqueous solution comprising uranyl ions, the aqueous solution's temperature may be controlled using a temperature controlling device (operation 106a). For example, in various instances, while bubbling ozone (O₃) through the aqueous solution comprising uranyl ions, the aqueous solution may be maintained at a temperature of 0.1° C. to 99.9° C. In various instances, while bubbling ozone (O₃) through the aqueous solution comprising uranyl ions, the aqueous solution may be maintained at a temperature of 0.5° C. to 99.5° C.; 1° C. to 99° C.; 5° C. to 95° C.; 10° C. to 90° C.; 15° C. to 85° C.; 20° C. to 80° C.; 25° C. to 75° C.; 30° C. to 70° C.; 35° C. to 65° C.; or 40° C. to 60° C. In various instances, while bubbling ozone (O₃) through the aqueous solution comprising uranyl ions, the aqueous solution may be maintained at a temperature of no greater than 99.9° C.; no greater than 99.5° C.; no greater than 99° C.; no greater than 95° C.; no greater than 90° C.; no greater than 85° C.; no greater than 80° C.; no greater than 75° C.; no greater than 70° C.; no greater than 65° C.; no greater than 60° C.; no greater than 55° C.; no greater than 50° C.; no greater than 45° C.; no greater than 40° C.; no greater than 35° C.; no greater than 30° C.; or no greater than 25° C. In various instances, while bubbling ozone (O₃) through the aqueous solution comprising uranyl ions, the aqueous solution may be maintained at a temperature of no less than 0.1° C.; no less than 0.5° C.; no less than 1° C.; no less than 5° C.; no less than 10° C.; no less than 15° C.; no less than 20° C.; no less than 25° C.; no less than 30° C.; no less than 35° C.; no less than 40° C.; no less than 45° C.; no less than 50° C.; no less than 55° C.; no less than 60° C.; no less than 65° C.; no less than 70° C.; no less than 75° C.; no less than 80° C.; no less than 85° C.; no less than 90° C.; or no less than 95° C.

In some implementations, while bubbling ozone (O₃) through the aqueous solution comprising uranyl ions, the aqueous solution environment's pressure may be controlled using a pressure controlling device (operation 106b). For example, in various instances, while bubbling ozone (O₃) through the aqueous solution comprising uranyl ions, the aqueous solution's environment may be maintained at a pressure of 0.0001 MPa to 1.0 MPa. In various instances, while bubbling ozone (O₃) through the aqueous solution comprising uranyl ions, the aqueous solution's environment may be maintained at a pressure of 0.001 MPa to 0.999 MPa; 0.005 MPa to 0.995 MPa; 0.01 MPa to 0.99 MPa; 0.025 MPa to 0.975 MPa; 0.05 MPa to 0.95 MPa; 0.075 MPa to 0.925 MPa; 0.1 MPa to 0.9 MPa; 0.15 MPa to 0.85 MPa; 0.2 MPa to 0.8 MPa; 0.25 MPa to 0.75 MPa; 0.3 MPa to 0.7 MPa; 0.35 MPa to 0.65 MPa; or 0.4 MPa to 0.6 MPa. In various instances, while bubbling ozone (O₃) through the aqueous solution comprising uranyl ions, the aqueous solution's environment may be maintained at a pressure of no greater than 1.0 MPa; no greater than 0.999 MPa; no greater than 0.995 MPa; no greater than 0.99 MPa; no greater than 0.95 MPa; no greater than 0.9 MPa; no greater than 0.8 MPa; no greater than 0.7 MPa; no greater than 0.6 MPa; no greater than 0.5 MPa; no greater than 0.4 MPa; no greater than 0.3 MPa; no greater than 0.2 MPa; no greater than 0.1 MPa; no greater than 0.075 MPa; no greater than 0.05 MPa; no greater than 0.025 MPa; no greater than 0.01 MPa; or no greater than 0.005 MPa. In various instances, while bubbling ozone (O₃) through the aqueous solution comprising uranyl ions, the aqueous solution's environment may be maintained at a pressure of no less than 0.0001 MPa; no less than 0.001 MPa; no less than 0.005 MPa; no less than 0.01 MPa; no less than 0.025 MPa; no less than 0.05 MPa; no less than 0.075 MPa; no less than 0.1 MPa; no less than 0.2 MPa; no less than 0.3 MPa; no less than 0.4 MPa; no less than 0.5 MPa; no less than 0.6 MPa; no less than 0.7 MPa; no less than 0.8 MPa; no less than 0.9 MPa; no less than 0.95 MPa; or no less than 0.99 MPa.

### C. Exemplary Post-Ozone (O₃) Bubbling Operations

After bubbling ozone (O₃) through the aqueous solution comprising uranyl ions (operation 104), exemplary method 100 may further include recovering the peroxide of uranium (operation 108). Exemplary recovery methods include separating a solids portion comprising the peroxide of uranium from a liquids portion comprising filtrate.

Post-ozone (O₃) bubbling, at least 80% of the uranium in the aqueous solution may be recovered as the peroxide of uranium. In some instances, at least 80%; at least 85%; at least 90%; or at least 95% of the uranium in the aqueous solution may be recovered as the peroxide of uranium.

Exemplary recovered peroxides of uranium may be washed with water. In some instances, exemplary recovered peroxides of uranium may be washed with water in a vacuum filtration system.

In various instances, exemplary recovered peroxides of uranium may be dried at various temperatures for various time periods. In some instances, drying exemplary peroxides of uranium, e.g., studtite (UO₄·4(H₂O)), induces dehydration, thereby forming a different peroxide of uranium, e.g., metastudtite (UO₄·2(H₂O)).

In various instances, exemplary recovered peroxides of uranium may be dried at a temperature of 75° C. to 85° C. for a time period of 20 hours to 28 hours. In various instances, exemplary recovered peroxides of uranium may be dried at a temperature of 76.5° C. to 84.5° C.; 76° C. to 84° C.; 76.5° C. to 83.5° C.; 77° C. to 83° C.; 77.5° C. to 82.5° C.; 78° C. to 82° C.; 78.5° C. to 81.5° C.; 79° C. to 81° C.; or 79.5° C. to 80.5° C. In various instances, exemplary recovered peroxides of uranium may be dried at a temperature of no greater than 85° C.; no greater than 84° C.; no greater than 83° C.; no greater than 82° C.; no greater than 81° C.; no greater than 80° C.; no greater than 79° C.; no greater than 78° C.; no greater than 77° C.; or no greater than 76° C. In various instances, exemplary recovered peroxides of uranium may be dried at a temperature of no less than 75° C.; no less than 76° C.; no less than 77° C.; no less than 78° C.; no less than 79° C.; no less than 80° C.; no less than 81° C.; no less than 82° C.; no less than 83° C.; or no less than 84° C.

In various instances, exemplary recovered peroxides of uranium may be dried for a time period of 21 hours to 27 hours; 21.5 hours to 26.5 hours; 22 hours to 26 hours; 22.5 hours to 25.5 hours; 23 hours to 25 hours; or 23.5 hours to 24.5 hours. In various instances, exemplary recovered peroxides of uranium may be dried for a time period of no greater than 28 hours; no greater than 27 hours; no greater than 26 hours; no greater than 25 hours; no greater than 24 hours; no greater than 23 hours; no greater than 22 hours; or no greater than 21 hours. In various instances, exemplary recovered peroxides of uranium may be dried for a time period of no less than 20 hours; no less than 21 hours; no less than 22 hours; no less than 23 hours; no less than 24 hours; no less than 25 hours; no less than 26 hours; or no less than 27 hours.

In some instances, various recovered peroxides of uranium, e.g., studtite (UO₄·4(H₂O)) or metastudtite (UO₄·2(H₂O)), may be transformed into UO₃ (uranium (VI) oxide) by heating the recovered peroxide of uranium at a temperature of 400° C. to 500° C. for a time period of 20 hours to 28 hours. In various instances, exemplary peroxides of uranium may be heated at a temperature of 400° C. to 500° C. for a time period of 21 hours to 27 hours; 21.5 hours to 26.5 hours; 22 hours to 26 hours; 22.5 hours to 25.5 hours; 23 hours to 25 hours; or 23.5 hours to 24.5 hours. In various instances, exemplary peroxides of uranium may be heated at a temperature of 400° C. to 500° C. for a time period of no greater than 28 hours; no greater than 27 hours; no greater than 26 hours; no greater than 25 hours; no greater than 24 hours; no greater than 23 hours; no greater than 22 hours; or no greater than 21 hours. In various instances, exemplary peroxides of uranium may be heated at a temperature of 400° C. to 500° C. for a time period of no less than 20 hours; no less than 21 hours; no less than 22 hours; no less than 23 hours; no less than 24 hours; no less than 25 hours; no less than 26 hours; or no less than 27 hours.

In some instances, exemplary peroxides of uranium may be heated for a time period of 20 hours to 28 hours at a temperature of 410° C. to 490° C.; 420° C. to 480° C.; 430° C. to 470° C.; or 440° C. to 460° C. In various instances, exemplary peroxides of uranium may be heated for a time period of 20 hours to 28 hours at a temperature of no greater than 500° C.; no greater than 490° C.; no greater than 480 CC; no greater than 470° C.; no greater than 460° C.; no greater than 450 CC; no greater than 440° C.; no greater than 430° C.; no greater than 420° C.; or no greater than 410° C. In various instances, exemplary peroxides of uranium may be heated for a time period of 20 hours to 28 hours at a temperature of no less than 400° C.; no less than 410° C.; no less than 420° C.; no less than 430° C.; no less than 440° C., no less than 450° C.; no less than 460° C.; no less than 470° C.; no less than 480° C.; or no less than 490° C.

### IV. Exemplary Systems

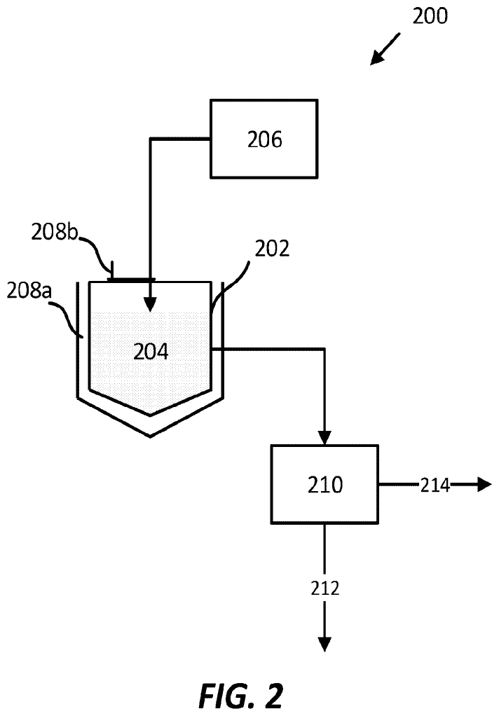

Various systems may be used to perform exemplary methods and techniques described herein. FIG. 2 is a schematic illustration of an exemplary system 200 for preparing exemplary peroxides of uranium. Exemplary system 200 includes a vessel 202, an aqueous solution comprising uranyl ions (UO₂⁺²) 204, an ozone (O₃) source 206, and a filter unit 210. Other embodiments may include more or fewer components.

In various instances, the vessel 202 may contain the aqueous solution comprising uranyl ions (UO₂⁺²) 204, and the vessel 202 may be in fluid communication with the ozone (O₃) source 206.

In some implementations, the vessel 202 may further include temperature regulation components 208a configured to maintain a predetermined aqueous solution 204 temperature. For instance, exemplary temperature regulation components 208a may maintain an aqueous solution 204 temperature of from 0.1° C. to 99.9° C.

In some implementations, the vessel 202 may also include pressure regulation components 208b configured to maintain a predetermined pressure in vessel 202. For instance, exemplary pressure regulation components 208b may maintain vessel 202 pressure of from 0.0001 MPa to 1.0 Mpa.

In some instances, a filter unit 210 may be in fluid communication with the vessel 202. Exemplary filter units 210 may be configured to generate a solids portion 212 comprising the peroxide of uranium and a liquid portion 214 comprising filtrate.

### V. Experimental Examples

Without limiting the scope of the instant disclosure, experimental examples of embodiments discussed above were prepared and the results are discussed below.

### A. Materials and Methods

A 0.5 M solution of aqueous uranyl nitrate hexahydrate (UO₂(NO₃)₂·6(H₂O)), was prepared for a purging experiment with ozone gas. A 1 mL aliquot of the 0.5 M uranyl nitrate hexahydrate was diluted to 7 mL in a 2-dram glass vial yielding a final concentration of approximately 0.07 M. A syringe needle was fitted to the end of Norprene® tubing attached to the ozone generator. The needle was placed in the solution to allow for continuous contact of ozone with the solution. Vigorous bubbling inside of the vial was observed after turning on the ozone generator. The solution was purged with ozone for a total of 15 hours.

All contents of the vial were removed via pipet and transferred to microcentrifuge tubes. The tubes were placed in a centrifuge set to 6000 rpm for two minutes. After centrifugation, a yellow precipitate was observed at the bottom of the tube. The supernatant was decanted off, and the solid was transferred to a glass slide. The yellow solid displayed optical properties characteristic of the uranyl peroxide mineral, studtite (UO₂·4(H₂O)).

### B. Results

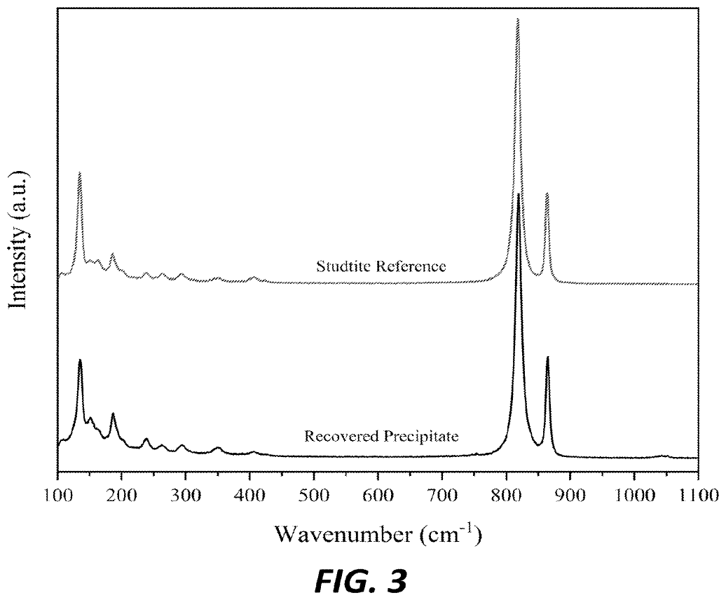

The recovered precipitate was analyzed via Raman spectroscopy and powder X-ray diffraction. The Raman spectrum of the recovered precipitate was plotted against the Raman spectrum of reference studtite (FIG. 3). As shown in FIG. 3, there is good agreement between the recovered solid and pristine studtite. Characteristic signals at 820 cm⁻¹ and 864 cm⁻¹ distinguish studtite from other uranyl compounds, representing the uranyl symmetric stretching mode (v₁ UO₂²⁺) and peroxo symmetric stretching mode (v₁ O-O), respectively (FIG. 3).

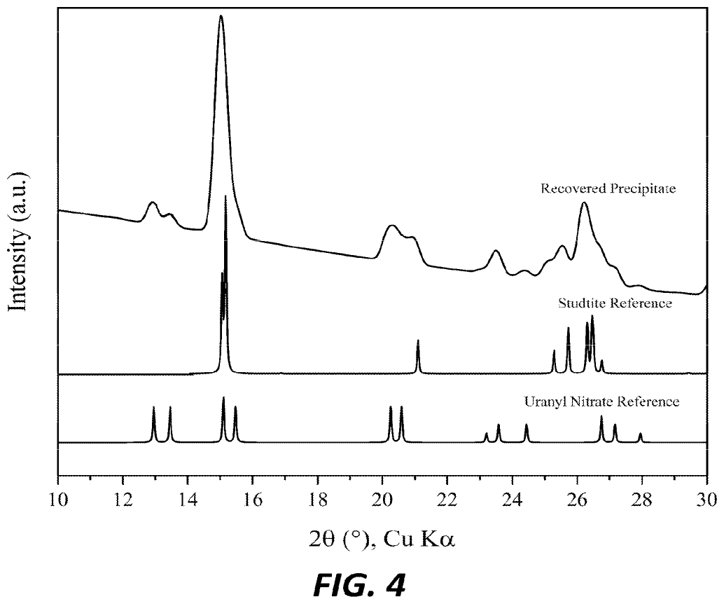

Powder X-ray diffraction was collected on a 100 m particle of the recovered precipitate. As shown in FIG. 4, the X-ray diffraction pattern of the recovered precipitate was plotted against the X-ray diffraction pattern of a studtite reference. The relative intensities of the X-ray diffraction pattern reflections support that the recovered precipitate is studtite (FIG. 4).

For reasons of completeness, various aspects of the technology are set out in the following numbered embodiments:
Embodiment 1. A method of producing a peroxide of uranium, the method comprising:
   preparing an aqueous solution comprising uranyl ions (UO₂⁺²) in a vessel;
   bubbling ozone (O₃) through the aqueous solution comprising the uranyl ions; and recovering the peroxide of uranium.
Embodiment 2. The method according to embodiment 1, wherein the peroxide of uranium comprises at least one of studtite (UO₄·4(H₂O)) or metastudtite (UO₄·2(H₂O)).
Embodiment 3. The method according to embodiment 1 or 2, wherein the uranyl ion source comprises a uranyl salt.
Embodiment 4. The method according to any one of embodiments 1-3, wherein the uranyl salt comprises UO₂(NO₃)₂, UO₂SO₄, UO₂CO₃, or UO₂(CH₃CO₂)₂.
Embodiment 5. The method according to any one of embodiments 1-4, wherein the aqueous solution comprising uranyl ions has a pH of less than 9.
Embodiment 6. The method according to any one of embodiments 1-5, wherein the aqueous solution comprising uranyl ions has a pH of 3-6.
Embodiment 7. The method according to any one of embodiments 1-6, wherein bubbling ozone (O₃) through the aqueous solution comprising uranyl ions occurs for a time period of 1 minute to 72 hours.
Embodiment 8. The method according to any one of embodiments 1-7, wherein, while bubbling ozone (O₃) through the aqueous solution comprising uranyl ions occurs for a time period of 12 hours to 58 hours.
Embodiment 9. The method according to any one of embodiments 1-8, wherein, while bubbling ozone (O₃) through the aqueous solution comprising the uranyl ions, the aqueous solution is maintained at a temperature of 0.1° C. to 99.9° C.
Embodiment 10. The method according to any one of embodiments 1-9, wherein, while bubbling ozone (O₃) through the aqueous solution comprising the uranyl ions, the aqueous solution is maintained at a temperature of 30° C. to 60° C.
Embodiment 11. The method according to any one of embodiments 1-10, wherein, while bubbling ozone (O₃) through the aqueous solution comprising the uranyl ions, the aqueous solution is maintained at a pressure of 0.0001 MPa to 1.0 MPa.
Embodiment 12. The method according to any one of embodiments 1-11, wherein an ozone diffuser bubbles the ozone (O₃) through the aqueous solution comprising the uranyl ions.
Embodiment 13. The method according to any one of embodiments 1-12, wherein bubbling ozone (O₃) comprises contacting the aqueous solution comprising the uranyl ions with a bubbling tube, diffusing stone, or needle.
Embodiment 14. The method according to any one of embodiments 1-13, wherein the ozone bubbles have an average diameter of 1 μm to 10,000 μm.
Embodiment 15. The method according to any one of embodiments 1-14, wherein ozone is provided into the aqueous solution at a flow rate of 0.01 standard cubic centimeters per minute (MPa·cm³/min) to 100 MPa·cm³/min.
Embodiment 16. The method according to any one of embodiments 1-15, wherein, while bubbling ozone (O₃) through the aqueous solution comprising the uranyl ions, the aqueous solution has an ozone content of greater than about 10 parts per billion (ppb).
Embodiment 17. A system for generating a peroxide of uranium, the system comprising: a vessel containing an aqueous solution comprising uranyl ions (UO₂⁺²), wherein the vessel is in fluid communication with an ozone (O₃) source and a filter unit.
Embodiment 18. The system according to embodiment 17, wherein the uranyl ion source comprises a uranyl salt.
Embodiment 19. The system according to embodiment 17 or 18, wherein the ozone (O₃) source comprises a bubbling tube in fluid communication with an ozone diffuser.
Embodiment 20. The system according to any one of embodiments 17-19, wherein the filter unit is configured to generate a solids portion comprising the peroxide of uranium and a liquid portion comprising filtrate.
Embodiment 21. The system according to any one of embodiments 17-20, wherein the peroxide of uranium comprises at least one of studtite (UO₄·4(H₂O)) or metastudtite (UO₄·2(H₂O)).
Embodiment 22. A peroxide of uranium, wherein the peroxide of uranium is formed by a process comprising:
   preparing an aqueous solution comprising uranyl (UO₂⁺²) ions in a vessel;
   bubbling ozone (O₃) through the aqueous solution comprising the uranyl ions; and recovering the peroxide of uranium.
Embodiment 23. The peroxide of uranium according to embodiment 22, wherein the peroxide of uranium comprises at least one of studtite (UO₄·4(H₂O)) or metastudtite (UO₄·2(H₂O)).

1. A method of producing a peroxide of uranium, the method comprising:
preparing an aqueous solution comprising uranyl ions (UO₂⁺²) in a vessel;
bubbling ozone (O₃) through the aqueous solution comprising the uranyl ions; and
recovering the peroxide of uranium.

2. The method according to claim 1, wherein the peroxide of uranium comprises at least one of studtite (UO₄·4(H₂O)) or metastudtite (UO₄·2(H₂O)).

3. The method according to claim 1, wherein the uranyl ion source comprises a uranyl salt.

4. The method according to claim 3, wherein the uranyl salt comprises UO₂(NO₃)₂, UO₂SO₄, UO₂CO₃, or UO₂(CH₃CO₂)₂.

5. The method according to claim 1, wherein the aqueous solution comprising uranyl ions has a pH of less than 9.

6. The method according to claim 1, wherein the aqueous solution comprising uranyl ions has a pH of 3-6.

7. The method according to claim 1, wherein bubbling ozone (O₃) through the aqueous solution comprising uranyl ions occurs for a time period of 1 minute to 72 hours.

8. The method according to claim 1, wherein, while bubbling ozone (O₃) through the aqueous solution comprising uranyl ions occurs for a time period of 12 hours to 58 hours.

9. The method according to claim 1, wherein, while bubbling ozone (O₃) through the aqueous solution comprising the uranyl ions, the aqueous solution is maintained at a temperature of 0.1° C. to 99.9° C.

10. The method according to claim 1, wherein, while bubbling ozone (O₃) through the aqueous solution comprising the uranyl ions, the aqueous solution is maintained at a temperature of 30° C. to 60° C.

11. The method according to claim 1, wherein, while bubbling ozone (O₃) through the aqueous solution comprising the uranyl ions, the aqueous solution is maintained at a pressure of 0.0001 MPa to 1.0 MPa.

12. The method according to claim 1, wherein an ozone diffuser bubbles the ozone (O₃) through the aqueous solution comprising the uranyl ions.

13. The method according to claim 1, wherein bubbling ozone (O₃) comprises contacting the aqueous solution comprising the uranyl ions with a bubbling tube, diffusing stone, or needle.

14. The method according to claim 1, wherein the ozone bubbles have an average diameter of 1 μm to 10,000 μm.

15. The method according to claim 1, wherein ozone is provided into the aqueous solution at a flow rate of 0.01 standard cubic centimeters per minute (MPa·cm³/min) to 100 MPa·cm³/min.

16. The method according to claim 1, wherein, while bubbling ozone (O₃) through the aqueous solution comprising the uranyl ions, the aqueous solution has an ozone content of greater than about 10 parts per billion (ppb).

17. A system for generating a peroxide of uranium, the system comprising:
a vessel containing an aqueous solution comprising uranyl ions (UO₂⁺²), wherein the vessel is in fluid communication with an ozone (O₃) source and a filter unit.

18. The system according to claim 17, wherein the uranyl ion source comprises a uranyl salt.

19. The system according to claim 17, wherein the ozone (O₃) source comprises a bubbling tube in fluid communication with an ozone diffuser.

20. The system according to claim 17, wherein the filter unit is configured to generate a solids portion comprising the peroxide of uranium and a liquid portion comprising filtrate.

21. The system according to claim 17, wherein the peroxide of uranium comprises at least one of studtite (UO₄·4(H₂O)) or metastudtite (UO₄·2(H₂O)).

22. A peroxide of uranium, wherein the peroxide of uranium is formed by a process comprising:
preparing an aqueous solution comprising uranyl (UO₂⁺²) ions in a vessel;
bubbling ozone (O₃) through the aqueous solution comprising the uranyl ions; and
recovering the peroxide of uranium.

23. The peroxide of uranium according to claim 22, wherein the peroxide of uranium comprises at least one of studtite (UO₄·4(H₂O)) or metastudtite (UO₄·2(H₂O)).
